(19) United States
(12) Patent Application Publication
(10) Pub. No.: US 2026/0283166 A1
(43) Pub. Date: Sep. 24, 2026

(54) CUTTING DEVICE AND METHOD

(71) Applicant: MAREL RED MEAT B.V., LICHTENVOORDE (NL)

(72) Inventors: Arno Hermanus Maria UEFFING, LICHTENVOORDE (NL); Leonardus Jozephus Antonius TIGGELOVEN, LICHTENVOORDE (NL); Maarten Thomas SCHUTTERT, LICHTENVOORDE (NL); Richard Antonius Maria KLEIN GOLDEWIJK, LICHTENVOORDE (NL)

(21) Appl. No.: 19/473,726

(22) PCT Filed: Mar. 15, 2024
(86) PCT No.: PCT/EP2024/057016

§ 371 Date: Oct. 8, 2025

(30) Foreign Application Priority Data
Apr. 28, 2023 (EP) 23170796.9

(51) Int. Cl. A22B 5/00; A22C 17/00

(52) U.S. Cl. CPC A22B 5/0029; A22B 5/0023; A22C 17/0006

(57) ABSTRACT

A cutting device is used for slicing food items, including beef or pork carcasses, and features a flat cutting body with at least one cutting edge, and drive means for driving rotation of the cutting body around a rotational axis. The drive means includes a direct drive motor with a stator and a rotor that rotates relative to the stator. The rotor is rigidly connected to the cutting body. The device is housed in a housing that contains the direct drive motor, and the cutting body has an opening on its inner side, with the stator and rotor extending within this opening.

### TECHNICAL FIELD

The present invention relates to a cutting device. In particular, the invention relates to a device, a body and a method for the cutting of food items, more in particular meat products such as beef or pork carcasses during slaughtering for instance for opening the abdominal cavity of an animal or for splitting carcasses.

### BACKGROUND

It is known in the art to make use of saw blades which are driven via a transmission by an electromotor. The transmission may include toothed belts, chains, and gears such as bevel gears. Such parts are subject to wear and need maintenance and may need oil for lubrication which oil forms a risk for contamination of a food product which is to be cut. An example of a device for opening the abdominal cavity of a slaughtered animal is described in the international patent application WO 93/01725 A1.

It is an object of the invention to provide an improved cutting device. It is a more specific object of the invention to provide a cutting device which requires less maintenance, and which does not require (transmission) lubricant oil or at least does not require lubricants near the product to be cut which might contaminate the product. It is also an object to provide a cutting device of which the design is simpler, which is relatively easy to (dis)assemble, which has a relatively low weight and which has smaller dimensions. It is a further object to provide a cutting device which is suitable to cut food items, more in particular meat products. Such food items can typically be of flexible material.

### SUMMARY

One or more of the above-mentioned objects have been achieved by a cutting device, by a cutting body and/or a cutting method according to the present invention.

According to an aspect, the invention relates to a cutting device for cutting food items, preferably for cutting beef or pork carcasses, comprising
a flat cutting body having at least one cutting edge,
drive means for driving rotation of the cutting body about a rotational axis, the drive means comprising a direct drive motor with a stator and a rotor which is rotatable with respect to the stator and which is rigidly connected to the cutting body,
a housing in which the direct drive motor is provided,
wherein the cutting body is provided with an opening at its inner side, the stator and the rotor extending within the opening.

In another aspect, the invention relates to a cutting body having a cutting edge, the cutting body being arranged for use in a cutting device according to the invention, the cutting body being provided with an opening at its inner side, allowing a stator and a rotor of the direct drive motor of the cutting device according to the invention to extend within the opening.

In yet another aspect, the invention relates to a method for cutting food items, preferably for cutting beef or pork carcasses, the method comprising the step of using a cutting device according to the invention.

An effect of the cutting device, cutting body and/or cutting method according to the invention, is that by using a direct drive motor, the driving axis of which is per definition aligned with the rotational axis, it is not necessary to make use of a transmission between the drive motor and the cutting body for driving of the cutting body. This allows the design and construction of the cutting device to be relatively simple and to allow relatively easy maintenance, such as for instance for replacing the cutting body. The invention also obviates the need for using lubricant oil, such as transmission lubricant oil, which in use of the invention for cutting food items will be advantageous because of the reduced risk of contamination of the food products. The feature that the cutting body is provided with an opening and that the stator and the rotor extend within said opening allows the cutting device, more particular the combination of the housing including the direct drive motor therein and the cutting body, to be relatively slim.

### DESCRIPTION OF EMBODIMENTS

The present invention is elucidated below with a detailed description. Unless otherwise defined or specified, all terms should be accorded a technical meaning consistent with the usual meaning in the art as understood by the skilled person.

In an embodiment the cutting body is disc shaped and has the at least one cutting edge at its radial outer side. The cutting edge may be a single edge which is circular. Alternatively, the cutting body may for instance have cutting teeth, which might be arranged in a circle, at its radial outer side each cutting tooth having a cutting edge at least over part of the length thereof facing in the direction in which the cutting body in use is rotated.

In an embodiment a radial inner part of the cutting body is also provided within the housing. Such embodiment may allow a stable and efficient positioning of the cutting body.

In an embodiment. In particular, in an embodiment in which the stator and the rotor each extend on opposite sides of the cutting body, the combination of the housing and the cutting body can be symmetrical or basically symmetrical with respect to a plane which is aligned with the plane of the flat cutting body. The dimensions of the housing on either side of the cutting body may therefore be limited thus reducing the risk that any cutting action of a product is obstructed since the cutting device, in particular its housing, is blocked by the product which is cut.

In an embodiment of the cutting body the opening of the cutting body in which the direct drive motor is provided has a diameter within the range of 10 cm to 35 cm, preferably within the range of 15 to 30 cm.

In an embodiment of the cutting body the ratio between the diameter of the opening and the diameter of the circle which is followed by the radial outer side of the cutting body during rotation thereof being within the range of 1:3 to 2:3.

In an embodiment the housing, or at least a part thereof, is rigidly connected to the cutting body. This may in use of the cutting device improve the stability of the cutting body during rotation thereof. In addition, this may reduce the need to make use of seals in the design of the cutting device to prevent parts, such as fluids, from a product to be cut, to enter the housing. Or at least such seals may be less critical and less subject to wear.

In an embodiment the cutting body is clamped between two clamping bodies. Each or at least one of such clamping bodies may be parts of the housing.

In an embodiment the housing comprising two covers which extend on opposite sides of the cutting body and which are rigidly connected with each other, and preferably also with the cutting body. Such embodiment may allow easy (dis)assembly of the housing and/or easy replacement of a cutting body.

In an embodiment the stator extends on the radial inside of the rotor. This means that the rotor extends on the outside of the rotor. In such a configuration the motor can produce more torque for the same build volume compared to a configuration in which the stator would extend on the radial outside of the rotor. A further advantage may be that the rigid connection between the rotor and the cutting body can be positioned at a position which is more radially outward with respect to an embodiment in which the stator would extend on the radial outside of the rotor. Such positioning of the rigid connection may simplify the connection between the rotor and the cutting body and/or may reduce the mechanical load on the connection in use of the cutting device.

In an embodiment the cutting device comprises an arm which extends partially or fully outside the housing and is rigidly connected to the stator. Such an arm can extend through an opening in the housing. Any part of the arm outside the housing can be connected to by any kind of manipulator, such as a robot, for movement of the cutting device with respect to any product to be cut for cutting such product.

In an embodiment the housing has a width of at most 20 cm, preferably at most 15 cm or at most 10 cm or at most 8 cm or at most 5 cm. The width extends parallel to the rotational axis.

In an embodiment the ratio of the width of the housing and the diameter of the circle which is followed by the radial outer side of the cutting body is within the range of 1:8 to 3:5, preferably within the range of 1:6 to 1:3. The diameter of the circle which is followed by the radial outer side of the cutting body can be within the range of 20 cm to 120 cm, preferably within the range of 30 cm to 90 cm. In general, the invention allows a slender design of the housing with the direct drive motor therein, with respect to above mentioned diameter of the cutting body, thus allowing movement of the housing through a product or at least through part of such product at the location where the product is cut.

To further improve the possibility of the cutting device, more in particular the housing thereof, to move through a product at the location where it is previously cut by the cutting body of the cutting device, in an embodiment the housing seen in cross section is tapered at its outer side. Due to such tapered shape, the housing can function as a wedge and move cut sides of the material of a (partially) cut product away from each other, in particular when the material of the product is flexible such as typically is the case for food products during a cutting movement of the cutting device.

The largest one of the stator and the rotor have, in an embodiment, a diameter within the range of 15 cm to 35 cm, preferably within the range of 20 cm to 30 cm and/or the direct drive motor has a maximum torque of 350 Nm, preferably of 250 Nm, more preferably of 200 Nm. Such cutting devices generally will be suitable for efficiently cutting food products.

In an embodiment the cutting device comprises a cooling system, preferably a water cooling system, for cooling the direct drive motor, the cooling system having cooling channels within the housing. Such cooling allows efficient use of the direct drive motor.

In an embodiment the combined weight of the cutting body, the stator, the rotor and the housing is at most 40 kg, preferably at most 30 kg, more preferably at most 25 kg and/or the combined weight of the cutting body, the stator, the rotor and the housing is at least 10 kg, preferably at least 15 kg, more preferably at least 20 kg. To limit mass inertia forces and in general to limit any forces acting on a manipulation device which in use may in general be combined with the cutting device according to the invention, it is advantageous to limit the above-mentioned combined weight.

In an embodiment the cutting device comprises a cooling system, preferably a water cooling system, for cooling the direct drive motor with a cooling fluid, the cooling system having a cooling fluid inlet, a cooling fluid outlet and a cooling channel extending within the housing between the cooling fluid inlet and the cooling fluid outlet. In use, in particular in slaughtering lines, the cutting device may be heavily loaded causing generation of a lot of heat which can effectively be cooled with a cooling system as defined above. Such cooling system could in general be advantageous for cooling cutting devices. Within this context the present invention also relates to a cutting device for cutting food items, preferably for cutting beef or pork carcasses, comprisin
a flat cutting body having at least one cutting edge,
drive means for driving rotation of the cutting body about a rotational axis, the drive means comprising a direct drive motor with a stator and a rotor which is rotatable with respect to the stator, the rotor being rigidly connected to the cutting body,
a housing in which the direct drive motor is provided, and
a cooling system, preferably a water cooling system, for cooling the direct drive motor with a cooling fluid, the cooling system having a cooling fluid inlet, a cooling fluid outlet and a cooling channel extending within the housing between the cooling fluid inlet and the cooling fluid outlet. The cooling system of such cutting device may also be embodied as specified below.

A very efficient cooling may be realized if the cooling channel extends over 360 degrees.

In a practical embodiment the cooling fluid inlet communicates with the cooling channel via an inlet channel which connects to the cooling channel at an inlet position and wherein the cooling fluid outlet communicates with the at least one outlet channel via an outlet channel which connects to the cooling channel at an outlet position.

The inlet position and the outlet position may be positioned opposite each other. This way cooling fluid can flow in two opposite directions from the inlet position and arrive at the outlet position from opposite directions thus contributing to effective cooling.

The effectiveness of the cooling may further benefit from the cooling channel comprising chambers at the inlet position and at the outlet position.

In a further embodiment the cooling channel at least over most of its length has an undulating shape, such as a zig-zag shape. Due to the undulating shape, the total length of the cooling channel may exceed the length of the circumference along which the cooling channel extends providing increased cooling capacity. In addition, the undulating shape may promote turbulence of cooling fluid within the cooling channel thus also contributing to the cooling capacity.

In an embodiment the cutting body has at least one, preferably more than one, further opening, arranged, preferably in a regular pattern, at the radial outer side of the opening.

In an embodiment of the method the rotational speed of the rotor is within the range of 750 rpm to 2000 rpm, preferably within the range of 1000 rpm to 1500 rpm and/or the speed of the cutting edge is within the range of 5 m/s to 100 m/s, preferably within the range of 15 m/s to 60 m/s, more preferably within the range of 20 m/s to 50 m/s. Such process parameters will generally be suitable for efficiently cutting food products.

### BRIEF DESCRIPTION OF DRAWINGS

The present invention is described hereinafter with reference to the accompanying drawings in which, on scale, an embodiment of the present invention is shown.

FIG. 1 shows, in 3-dimensional view, a cutting device according to the invention;

FIG. 2 shows, in side view, the cutting device according to FIG. 1;

FIG. 3 shows cross section III-III in FIG. 2;

FIGS. 4 and 5 show, in two respective 3-dimensional explosion views, the cutting device according to FIG. 1;

FIG. 6 shows an alternative embodiment of part of a cutting device according to the invention.

### DETAILED DESCRIPTION

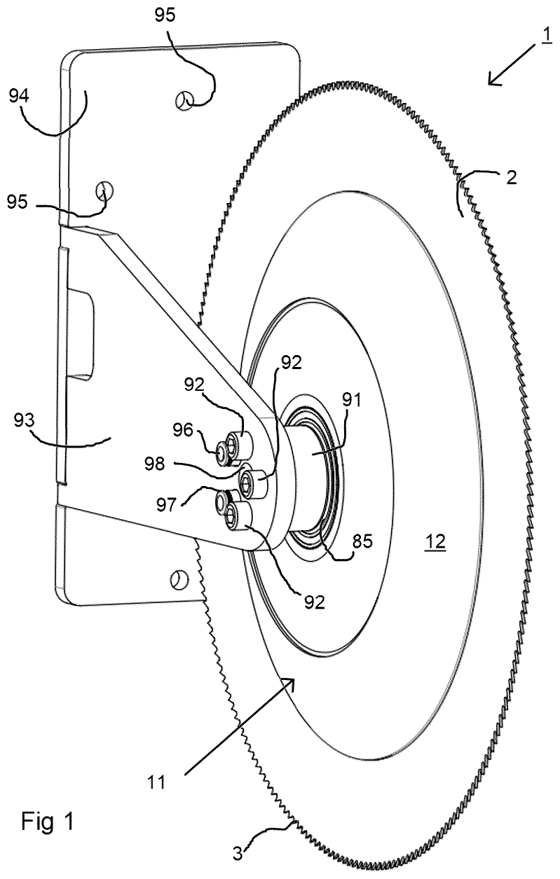

Cutting device 1, as shown in the respective FIGS. 1 to 5, is configured to cut food items, more in particular meat items, such as beef or pork carcasses. The material of such food items, with the exception of bones, is known to be flexible by its nature.

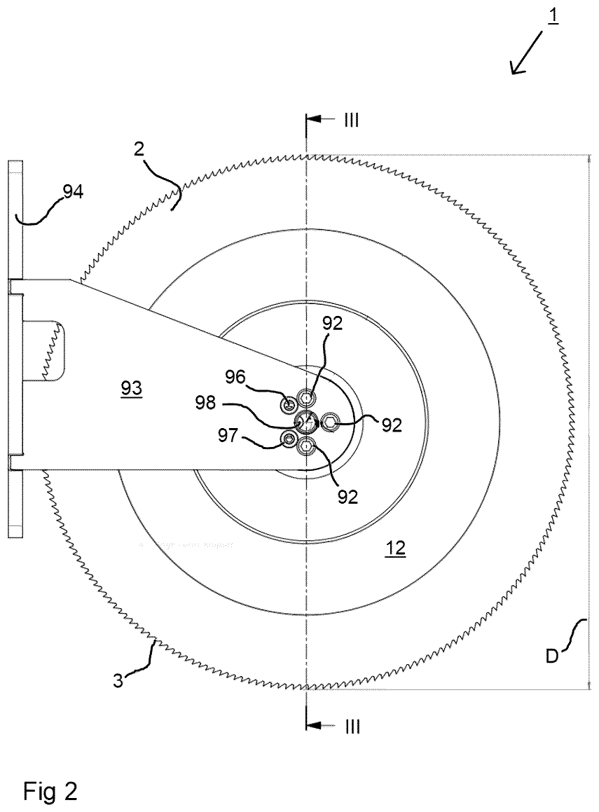

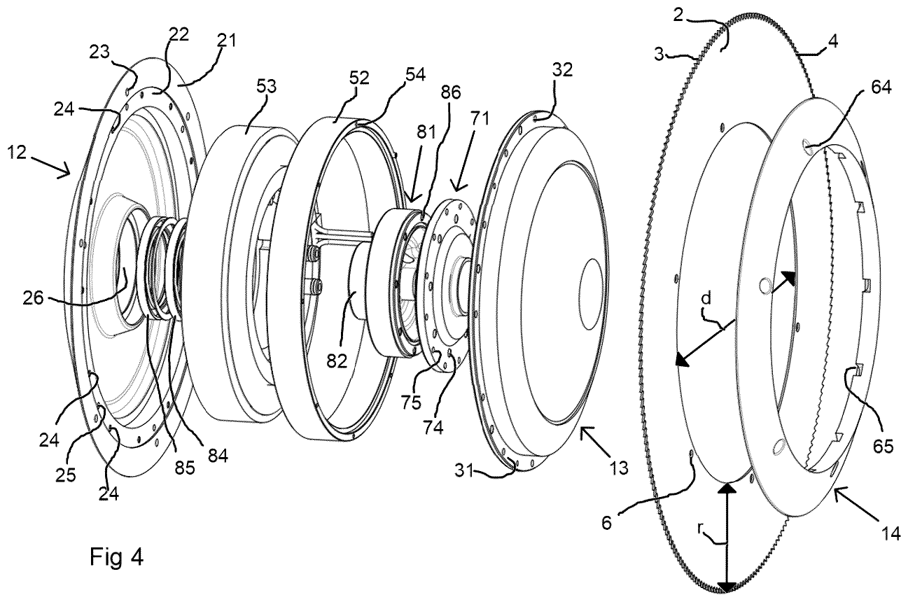

Cutting device 1 comprises a ring shaped, flat, cutting plate or cutting body 2 which is made from stainless steel. This cutting body 2 has a circular circumferential outer edge 3 which is provided with cutting tooth 4 each of which cutting teeth 4 having a cutting edge for cutting through the material of a product to be cut. The outer diameter D (FIG. 2) of the cutting body 2 is 45 cm. The cutting body 2 has a central circular opening 5 having a diameter d (FIG. 4) of 28 cm. From the above dimensions it follows that the radial dimension r (FIG. 4) of the ring of the cutting body 2 is 8,5 cm. The ratio d to D is 28 cm to 45 cm so about 0,62. The cutting body 2 is provided with six positioning holes 6 which are positioned at equal distances from each other just outside the circular opening 5.

As an example of an alternative embodiment for a cutting body 2 reference is made to cutting bodies having no teeth but instead have a smooth circular single cutting edge, to cutting bodies having an outer edge which has a spiral instead of circular shape and either is provided with a smooth spiral shaped single cutting edge or with cutting teeth. Such cutting bodies are also known as involute cutting blades. Another example of an alternative embodiment for a cutting body 2 is a propellor shaped cutting body having a hub for mounting on a rotatable axis and one or more blades extending radially from said hub. Such cutting bodies may be referred to as chopper knives.

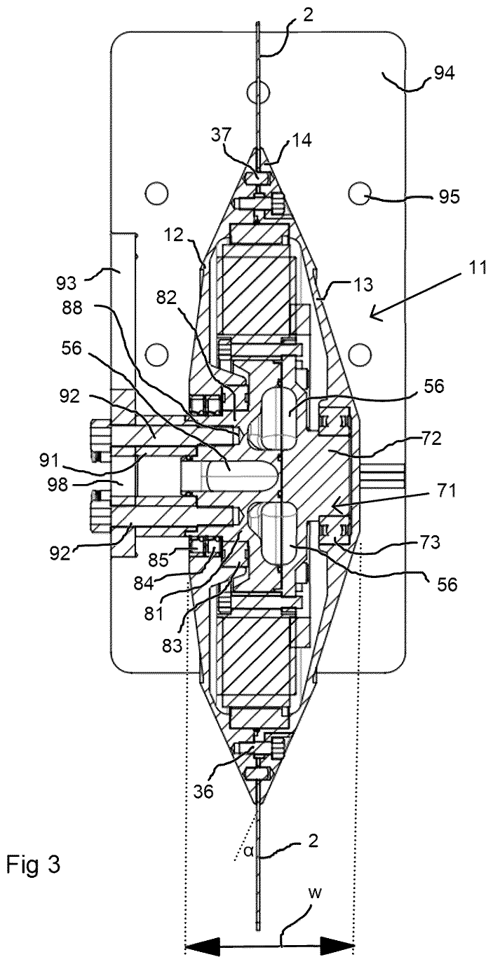

Cutting device 1 further comprises a housing 11. The housing 11 comprises two dome-shaped covers 12, 13 and a ring 14 which are interconnected as will be explained in the following. The housing 11 has a width w (FIG. 3) of about 8,4 cm meaning that the ratio w to D is 8 cm to 45 cm is 0,19. The housing 11 extends on opposite sides of the cutting body. The cross section of the housing 11 as shown in FIG. 3 is be it not exactly but still basically symmetrical with respect to an imaginary mirror plane which is aligned with the main plane of the cutting body 2. At its radial outer side, the housing 11 has a tapered shape the tapered angle a (FIG. 3) being about 24 degrees and in general preferably being within the range of 20 degrees to 30 degrees.

As shown in FIG. 4 cover 12 comprises, at its axial inner side, i.e. the side facing cover 13, an outer ring-shaped face 21 and an inner ring-shaped face 22. In the outer ring-shaped face 21 six positioning holes 23 are provided which are aligned with the positioning holes 6 of the cutting body 2. In the inner ring-shaped face 22 six sets of three holes 24, 25, 24 are provided. The outer ones of these three holes are screw holes 24 and the middle one of the three holes is also a screw hole 25. Cover is provided with a central opening 26.

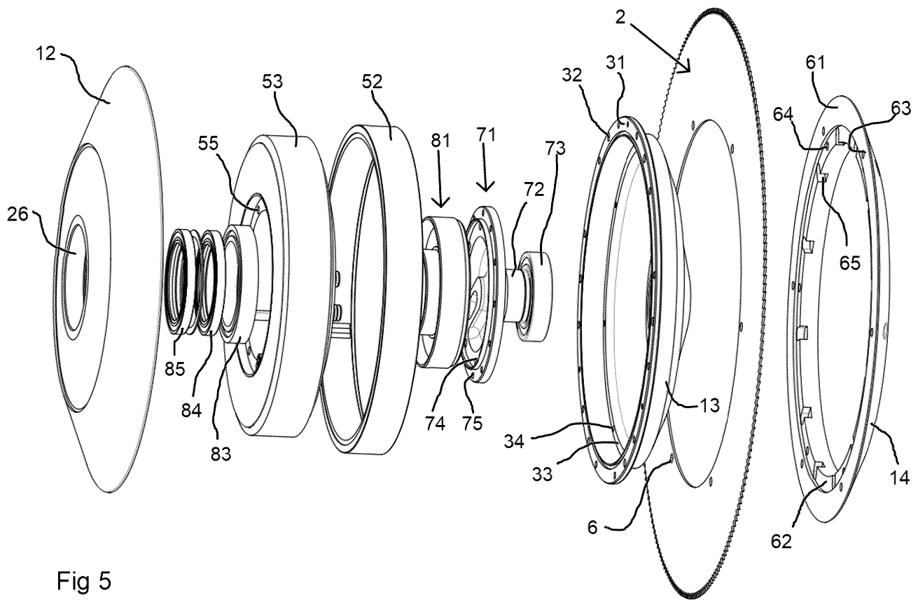

Cover 13 is provided at its radial outer side with a circular flange 31 in which potholes 32 are provided. The outer diameter of the flange 31 is such that flange 31 fits with limited play within the central opening 5 of the cutting body 2. Potholes 32 of cover 13 are aligned with screw holes 24 of cover 12. At its axial inner side and radially inward with respect to the flange 31, cover 13 is provided with a ring-shaped face 33 in which eight positioning holes 34 are provided at equal distances from each other. Covers 12 and 13 are detachably connected with each other via bolts (not shown) which are screwed from the right-hand side in FIGS. 4 and 5 via some of the potholes 32 in screw holes 24. When screwed together the covers 12, 13 enclose an accommodating space in which a direct drive motor 51 is accommodated for driving rotation of the cutting body 2 as will be discussed at a later stage.

Ring 14 is provided at its axial inner side, i.e. the side facing towards cutting body 2, with an outer ring-shaped face 61 and an inner ring-shaped face 62. In the outer ring-shaped face 61 six positioning holes 63 are provided which are aligned with the positioning holes 6 of the cutting body 2 and consequently also with the positioning holes 23 of the cover 12. In the inner ring-shaped face 62 six potholes 64 are provided which are aligned with potholes 32 of cover 13 which are not occupied by screws which are screwed in screw holes 24 of cover 12 and with the six positioning holes 25 of the cover 12. Screws 36 extend through said potholes 32 of cover 13 and are screwed in the screw holes 24 of cover 12. For each of the twelve screw holes 24 the inner ring-shaped face 62 is provided with a recess 65 which provides space for the heads of the bolts which are screwed in the screw holes 24.

The cutting body 2 is clamped between the outer face 61 of the ring 14 and the outer face 21 of the cover 12 for which screws (not shown but like screws 36) are screwed from the right-hand side in FIGS. 4 and 5 via potholes 64 of cover 14, into screw holes 25 of cover 12. For replacement of a cutting body 2 the screws in potholes 64 need to be unscrewed so that ring 14 can be removed and the cutting body 2 can be replaced. During such replacement covers 12 and 13 remain fixed together. In order to properly position the cutting body 2 with respect to the housing 11 also six positioning pins 37 are applied which with one end extend within a positioning hole 63 of ring 14, with the other end within a positioning hole 23 of cover 12 and there between through a hole 6 of the cutting body 2.

The aforementioned direct drive motor 51 is of the outrunner type wherein the rotor 52 of the drive motor 51 is radially on the outer side of the stator 53 of the drive motor 51 and has a relatively high maximum continuous torque of 100 Nm and its peak torque is about 150 Nm. The combined weight of the drive motor 51 and the housing 11 is at most 38 kg, preferably at most 28 kg, more preferably at most 23 kg and/or the combined weight of the cutting body, the stator, the rotor and the housing being at least 8 kg, preferably at least 13 kg, more preferably at least 18 kg. At the side facing the cover 13 the rotor 52 is provided with eight positioning holes 54 which are aligned with positioning holes 34 of cover 13. Positioning pins (not shown) extend with their ends both in the positioning holes 34 and the positioning holes 54 causing the cover 13, and consequently the housing 11 and the cutting body 2 to rotate in use together with the rotor 52.

Drive motor 51 also comprises a motor cover 71 having a shaft part 72 around which a bearing 73 is provided which bearing 73 extends within a recess at the inner side of the cover 13. Drive motor 51 further comprises a shaft body 81 which also has a shaft part 82 which is directed in opposite direction with respect to the direction of shaft part 72, which shaft part 82 extends through the central opening 26 of the cover 12 and around which a bearing 83 is provided which bearing 83 extends within a recess at the inner side of the cover 12. At the axially outer side of the bearing 83 two seal rings 84, 85 are provided around the shaft part 82. The motor cover 71 and the shaft body 81 are interconnected via screws (not shown) which are screwed from the right to the left in FIGS. 4 and 5 via inner holes 74 in cover 71 into screw holes 86 in shaft body 81. The motor cover 71 and the rotor 53 are interconnected via screws 87 which are screwed from the left to the right in FIGS. 4 and 5 through holes 55 in stator 53 into screw holes 75 of the motor cover 71. Drive motor 51 is also provided with cooling channels 56 through which in use of the cutting device 1 cooling fluid, such as preferably water, flows for cooling the drive motor.

A cylindrical connecting element 91 is screwed with screws 92 to the shaft body 81. The screws 91 extend through holes of a connecting plate 93, and through holes in the wall of the connecting element 91 into screw holes 88 of the shaft body 81. On connecting plate 93 furthermore fluid connections 96, 97 are provided which in use are to be connected to fluid hoses for allowing cooling fluid to flow to the cooling channels 56 and away from those cooling channels 56 via the respective connections 96, 97. The connecting plate 93 has a central opening 98 through which in use power cables (not shown) extend to electrically feed the windings of the stator 53. Connecting plate 93 extends parallel to the cutting body 2 and is connected to a further connecting plate 94 with holes 95 therein for connection to a manipulator. Further connecting plate 94 extends perpendicular to connecting plate 93 and is symmetrical with respect to the cutting body 2 seen in the view according to FIG. 3.

The cutting device 1 as described in use may be moved by the manipulator with respect to an object which is to be cut, such as for instance a pig carcass for splitting its spine or for opening its belly, such that the cutting body 2 makes the required cut. Typically, the in use rotational speed of the rotor, so also of the cutting body 2, is between 750 and 2000 rotations per minute (rpm) and/or the speed of the outer edge 3 of the cutting body is in the range of 5 to 100 meter per second (m/s).

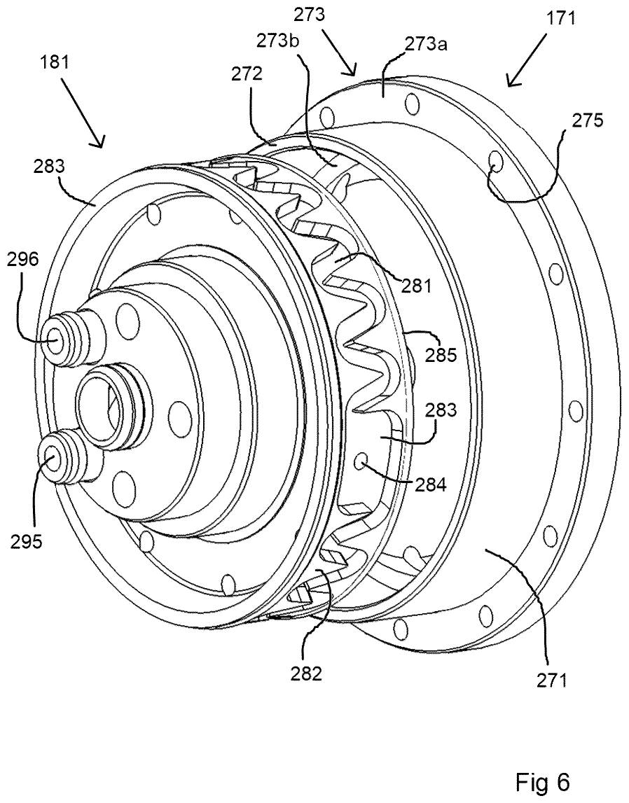

FIG. 6 relates to an alternative embodiment of a cutting device. Such cutting device differs from cutting device 1 in that motor cover 71 and shaft body 81 have been replaced by motor cover 171 and shaft body 181. Shaft body 181 differs from shaft body 81 in that a cooling channel 281 is provided at the outer circumference of the cylindrical part 282 of shaft body 181. The cooling channel 281 extends at the inner side of the rotor and the stator of the cutting device.

The shaft body 181 is provided with a small flange 283 which extends radially outwardly with respect to cylindrical part 282 of shaft body 181. The cooling channel 281 extends over the full circumference of cylindrical part 282 and comprises on opposite sides a chamber 283 of which only one is visible in FIG. 6. Between the two chambers 283 the cooling channel 281 has a has a zig-zag shape. The cooling channel 281 is machined in the cylindrical part 282 of the shaft body 181, more in particular on the outer side of the cylindrical part 282. The chamber 283 which is visible in FIG. 6 communicates via inlet channel 284 with cooling water inlet 295. The other, opposite, chamber which is not visible in FIG. 6, communicates via an outlet channel with cooling water outlet 296. In use cooling water will be provided via inlet 295 and inlet channel 284 to the chamber 283 which is visible in FIG. 6. From this chamber 283 the cooling water will flow in two opposite directions over 180 degrees via the two zig-zag shaped parts of the cooling channel 281 to the opposite chamber 283. From this opposite chamber 283 the cooling water, at that time a bit warmed up, will flow via an outlet channel which is comparable with inlet channel 284 to outlet 296. Due to its zig-zag shape over most of the length of the cooling channel 281, the total length of the cooling channel 281 exceeds the length of the circumference of cylindrical part 282 providing increased cooling capacity. In addition, the zig-zag shape promotes turbulence of cooling fluid within the channel 281 thus also contributing to the cooling capacity.

Motor cover 171 differs from motor cover 71 in that motor cover 171 has a cylindrical part 271 with on one end radial edge 272 and on the opposite end a flange 273 which extends with an outer flange part 273a on the outer side of the cylindrical part 271 and with an inner flange part 273b on an inner side of the cylindrical part 271. In the outer flange part 273a screw holes 275 like screw holes 75 are provided. When the motor cover 171 and shaft body 181 are mounted together the cylindrical part 271 closely covers the cylindrical part 282 and thus the cooling channel 281 therein. Its radial edge 272 sealingly engages flange 282 and likewise the radial edge 285 of the shaft body 181 sealingly engages inner flange part 273b. Appropriate sealing devices, such as sealing rings, may be used as will be understood by the person skilled in the art.

In a further alternative embodiment, a cooling channel such as like cooling channel 281 could be made in the inner side of the cylindrical part 271 of motor cover 171 instead of in cylindrical part 282 of shaft body 181. A cooling channel such as like cooling channel 281 could also extend both in the cylindrical parts 271 and 282 for which the motor cover 171 and the shaft body 181 should be properly aligned with respect to each other.

1-22. (canceled)

23. A cutting device for cutting food items, comprising:
a flat cutting body having at least one cutting edge,
drive means for driving rotation of the cutting body about a rotational axis, the drive means comprising a direct drive motor with a stator and a rotor which is rotatable with respect to the stator, the rotor being rigidly connected to the cutting body,
a housing in which the direct drive motor is provided wherein the cutting body is provided with an opening at its inner side, the stator and the rotor extending within the opening.

24. The cutting device according to claim 23, wherein the cutting body is disc shaped and has the at least one cutting edge at its radial outer side, the cutting edge is circular.

25. The cutting device according to claim 23, wherein a radial inner part of the cutting body is also provided within the housing.

26. The cutting device according to claim 23, wherein, the stator and the rotor each extending on opposite sides of the cutting body.

27. The cutting device according to claim 23, wherein the housing, or at least a part thereof, is rigidly connected to the cutting body and/or
wherein the cutting body is clamped between two clamping bodies.

28. The cutting device according to claim 23, wherein the stator extends on the radial inside of the rotor.

29. The cutting device according to claim 23, wherein the housing has a width of at most 20 cm.

30. The cutting device according to claim 23, wherein the diameter of the circle which is followed by the radial outer side of the cutting body is within the range of 20 cm to 120 cm.

31. The cutting device according to claim 23, wherein the housing seen in cross section is tapered at its outer side.

32. The cutting device according to claim 23, the combined weight of the cutting body, the stator, the rotor and the housing being at most 40 kg.

33. The cutting device according to claim 23, comprising a cooling system, including a water cooling system, for cooling the direct drive motor with a cooling fluid, the cooling system having a cooling fluid inlet, a cooling fluid outlet and a cooling channel extending within the housing between the cooling fluid inlet and the cooling fluid outlet.

34. The cutting device according to claim 33, wherein the cooling channel extends over 360 degrees.

35. The cutting device according to claim 34, wherein the cooling fluid inlet communicates with the cooling channel via an inlet channel which connects to the cooling channel at an inlet position and
wherein the cooling fluid outlet communicates with the at least one outlet channel via an outlet channel which connects to the cooling channel at an outlet position.

36. The cutting device according to claim 35, the inlet position and the outlet position being positioned opposite each other.

37. The cutting device according to claim 35, the cooling channel comprising chambers at the inlet position and at the outlet position.

38. The cutting device according to claim 33, wherein the cooling channel extends at the inner side of the rotor and stator.

39. The cutting device according to claim 33, wherein the cooling channel at least over most of its length has an undulating shape.

40. The cutting body having a cutting edge, the cutting body being arranged for use in a cutting device according to claim 23, the cutting body being provided with an opening at its inner side, allowing a stator and a rotor of a direct drive motor to extend within the opening.

41. The cutting body according to claim 40, the opening having a diameter within the range of 10 cm to 35 cm.

42. A method for cutting food items, the method comprising the step of using a cutting device according to claim 23.

43. The method according to claim 42, the rotational speed of the rotor within the range of 750 rpm to 2000 rpm.

44. The method according to claim 42, the speed of the cutting edge being within the range of 5 m/s to 100 m/s.
